(19) United States
(12) Patent Application Publication
(10) Pub. No.: US 2024/0178520 A1
(43) Pub. Date: May 30, 2024

(54) SECONDARY BATTERY SEPARATOR COMPRISING CELLULOSE COATING LAYER AND METHOD FOR MANUFACTURING THE SAME

(71) Applicant: UIF (University Industry Foundation), Yonsei University, Seoul (KR)

(72) Inventors: Sang-Young LEE, Seoul (KR); Young-Kuk HONG, Seoul (KR)

(73) Assignee: UIF (University Industry Foundation), Yonsei University, Seoul (KR)

(21) Appl. No.: 18/517,701

(22) Filed: Nov. 22, 2023

(30) Foreign Application Priority Data
Nov. 29, 2022 (KR) 10-2022-0163323

(51) Int. Cl. H01M 50/429; H01M 50/403; H01M 50/417; H01M 50/449; H01M 50/489

(52) U.S. Cl. CPC H01M 50/4295; H01M 50/403; H01M 50/417; H01M 50/449; H01M 50/489

(57) ABSTRACT

Disclosed is a secondary battery separator including a cellulose coating layer containing cellulose nanofibers and cellulose nanocrystals on a porous support. The secondary battery separator has a light weight, excellent air permeability and excellent puncture strength, and thus can provide a lithium secondary battery with excellent physical properties, including ion conductivity, wettability with an electrolyte and heat stability.

### CROSS-REFERENCE TO RELATED APPLICATION

This application claims priority to Korean Patent Application No. 10-2022-0163323 filed on Nov. 29, 2022, and all the benefits accruing therefrom under 35 U.S.C. § 119, the contents of which in its entirety are herein incorporated by reference.

### BACKGROUND

### 1. Field

The present disclosure relates to a secondary battery separator including a cellulose coating layer and a method for manufacturing the same.

### 2. Description of the Related Art

In general, a lithium secondary battery includes a positive electrode, a negative electrode, an electrolyte and a separator. Among them, it is required for the separator to separate and electrically insulate the positive electrode and the negative electrode from each other, while ensuring a sufficient level of porosity and air permeability to provide high lithium-ion conductivity.

In general, such a separator uses a polyolefin-based polymer, such as polyethylene or polypropylene. In the case of the polyolefin-based polymer, it is vulnerable to heat and causes a fatal problem in that it undergoes thermal deformation (heat shrinking) due to the heat generated during the charge/discharge of a secondary battery, resulting in degradation of the stability of the secondary battery.

To solve the above-mentioned problem, inorganic particles, such as ceramic particles, are coated on the separator to prevent the separator from heat shrinking. However, when using an acryl- or rubber-based adhesive material for such coating with inorganic particles, there are problems in that it is difficult to perform uniform coating with the inorganic particles, the porous separator shows reduced porosity and air permeability to interrupt migration of lithium ions, and it is also difficult to ensure the mechanical strength, such as puncture strength.

Under these circumstances, there has been an attempt to improve the puncture strength by introducing cellulose nanocrystals finer than cellulose nanofibers. However, in this case, the puncture strength is improved, but the air permeability is significantly decreased, thereby still causing the problem of degradation of the ion conductivity.

Therefore, there is an imminent need for research and development about a secondary battery separator having excellent puncture strength, low heat shrinkage and improved air permeability.

### SUMMARY

The present disclosure is directed to providing a secondary battery separator which includes a cellulose coating layer containing cellulose nanofibers and cellulose nanocrystals and has a low heat shrinkage and improved air permeability, and a method for manufacturing the same.

The present disclosure is also directed to providing a lithium secondary battery which includes a secondary battery separator having improved lithium-ion conductivity and excellent puncture strength and shows a significantly reduced risk of explosion caused by an internal short-circuit of a battery.

In one aspect, there is provided a secondary battery separator which includes a cellulose coating layer containing cellulose nanofibers and cellulose nanocrystals on one surface or both surfaces of a porous support, wherein the cellulose coating layer includes a continuous phase formed from a plurality of cellulose nanofibers having a chain entanglement structure and a dispersed phase formed from the cellulose nanocrystals.

According to an embodiment of the present disclosure, the cellulose nanocrystals may be present in an amount of 1-200 parts by weight based on 100 parts by weight of the cellulose nanofibers.

According to an embodiment of the present disclosure, the cellulose nanofibers may have an average diameter of 50-500 nm on the longitudinal section thereof.

According to an embodiment of the present disclosure, the cellulose nanofibers may have an average aspect ratio of 50-3000.

According to an embodiment of the present disclosure, the cellulose nanocrystals may have an average diameter of 1-50 nm on the longitudinal section thereof.

According to an embodiment of the present disclosure, the cellulose nanocrystals may have an average aspect ratio of 10-1000.

According to an embodiment of the present disclosure, the cellulose coating layer may be prepared from a cellulose coating composition including: cellulose nanofibers; cellulose nanocrystals; and a mixed solvent of water with an organic solvent having a higher boiling point than the boiling point of water.

According to an embodiment of the present disclosure, the cellulose coating layer may have a thickness of 1-10 μm.

According to an embodiment of the present disclosure, the cellulose coating layer may further include at least one selected from a dispersant and inorganic particles.

According to an embodiment of the present disclosure, the porous support includes any one selected from the group consisting of high-density polyethylene, low-density polyethylene, linear low-density polyethylene, ultrahigh-molecular weight polyethylene, polypropylene, polybutylene, polypentene, polypropylenepolyethylene terephthalate, polybutylene terephthalate, polyester, polyacetal, polyamide, polycarbonate, polyimide, polyetheretherketone, polyethersulfone, polyphenylene oxide, polyphenylene sulfide and polyethylene naphthalene, or a combination of two or more of them.

According to an embodiment of the present disclosure, the secondary battery separator may have an air permeability (Gurley value) of 600 s/100 cc air or less.

According to an embodiment of the present disclosure, the secondary battery separator may have a puncture strength of 5 N or more.

In another aspect, there is provided a secondary battery including the above-described secondary battery separator.

In still another aspect, there is provided a method for manufacturing a secondary battery separator, including a step of applying a cellulose coating composition containing cellulose nanofibers and cellulose nanocrystals onto one surface or both surfaces of a porous support to form a cellulose coating layer, wherein the solvent is a mixed solvent of water with an organic solvent having a higher boiling point than the boiling point of water, and the cellulose coating layer includes a continuous phase formed from a plurality of cellulose nanofibers having a chain entanglement structure and a dispersed phase formed from the cellulose nanocrystals.

According to an embodiment of the present disclosure, the organic solvent may include any one selected from the group consisting of butanol, dimethyl sulfoxide (DMSO), N,N-dimethylformamide (DMF), N-methyl-2-pyrrolidone (NMP), ethylene glycol (EG), acetic acid, acetic anhydride, hexamethylphosphoramide (HMPA), pyridine, toluene and xylene, or a combination of two or more of them.

According to an embodiment of the present disclosure, the mixed solvent may include water and the organic solvent at a weight ratio of 2-10:1.

According to an embodiment of the present disclosure, the coating composition may have a solid content of 1-20 wt %.

The secondary battery separator according to the present disclosure includes a cellulose coating layer containing cellulose nanofibers and cellulose nanocrystals on a porous support, wherein the cellulose coating layer includes a continuous phase formed from a plurality of cellulose nanofibers having a chain entanglement structure and a dispersed phase formed from the cellulose nanocrystals. The secondary battery separator has a light weight, excellent air permeability and excellent puncture strength, and thus shows excellent ion conductivity and wettability with an electrolyte. In addition, the secondary battery separator has excellent heat stability, and thus can provide a lithium secondary battery showing a significantly reduced risk of explosion caused by an internal short circuit of a battery.

### BRIEF DESCRIPTION OF THE DRAWINGS

FIGS. 1A to 1C are scanning electron microscopic (SEM) images illustrating the surface of the secondary battery separator according to each of Example 1 (FIG. 1A) and Comparative Examples 1 (FIG. 1B) and 2 (FIG. 1C).

FIG. 2 is a graph illustrating the plating-stripping test of the Li/Li symmetric cell including the secondary battery separator according to Example 1 in the form of a voltage curve depending on time under each test condition ((A) 1 mAh/cm² at 0.5 mA/cm² and (B) 1 mAh/cm² at 3 mA/cm²).

FIG. 3 is a schematic view illustrating the secondary battery separator according to an embodiment in which a one dimensional (1D) cellulose coating layer structure is formed to realize excellent lithium-ion conductivity.

### DETAILED DESCRIPTION

Exemplary embodiments now will be described more fully hereinafter with reference to the accompanying drawings, in which exemplary embodiments are shown. However, such exemplary embodiments are for illustrative purposes only, and the present disclosure may be embodied in many different forms and should not be construed as limited to the exemplary embodiments set forth therein.

In addition, unless otherwise stated, all technical and scientific terms have the same meaning as those generally understood by one of those skilled in the art to which this invention belongs. The terms used in the specification are only for effectively describing specific embodiments and are not intended to limit the present disclosure.

In addition, units used without special mention in this specification are based on weight, for example, the unit of % or ratio means wt % or weight ratio, and wt % means the weight % of any one ingredient in the composition unless otherwise stated.

As used herein, the singular forms “a”, “an” and “the” are intended to include the plural forms as well, unless the context clearly indicates otherwise.

In addition, the expression “a part includes or comprises an element” does not preclude the presence of any additional elements but means that the part may further include the other elements, unless otherwise stated.

In addition, in the specification, if a part of a layer, film, region, plate, etc. is “on” or “on top” of another part, this includes not only the case where the other part is “right on top” but also the case where there is another part in the middle.

Further, the numerical range used in the specification may include all possible combinations of lower and upper limits and all values within the range, logically derived increments in the form and width of the defined range, double-limited all values, and upper and lower limits of the numerical range limited to different forms. Values other than the numerical range that are likely to occur due to experimental errors or rounding of values are also included in the defined numerical range unless otherwise stated in the specification.

Hereinafter, the secondary battery separator according to the present disclosure will be explained in more detail.

The inventors of the present disclosure have conducted continuous studies in order to obtain a secondary battery separator having excellent puncture strength, low heat shrinkage and excellent air permeability without using any synthetic polymer binder, and thus have found that formation of a cellulose coating layer containing cellulose nanofibers and cellulose nanocrystals on a porous support can provide a separator with improved puncture strength and heat resistance characteristics without using separate inorganic particles and can ensure air permeability and ion conductivity with ease. The present disclosure is based on this finding.

Particularly, there is a serious difficulty in the technology of dispersing inorganic particles in an aqueous medium and coating an aqueous binder on a polyolefin-based support according to the related art, and thus the coating solution according to the related art is problematic in that it provides a significantly non-uniform inorganic particle coating layer on the support due to the poor coatability. Therefore, the present disclosure is directed to providing a secondary battery separator having excellent heat resistance without using inorganic particles.

In addition, according to the related art, there has been an attempt to coat nanocrystals on a separator in order to improve the puncture strength. However, when an excessively large amount of nanocrystals are used, there is a problem in that the puncture strength is improved but the air permeability is degraded contradictively.

To solve the above-mentioned problem, the inventors of the present disclosure have conducted intensive studies and have found that when cellulose nanocrystals are coated by using a mixed solvent of water with an organic solvent satisfying a specific condition, it is possible to improve the puncture strength and to ensure the air permeability with ease at the same time, thereby improving the physical properties complementarily. The present disclosure is based on this finding.

In this manner, it is possible to solve the problem caused by the addition of inorganic particles and cellulose nanocrystals according to the related art. The secondary battery separator according to the present disclosure includes a cellulose coating layer having a continuous phase formed from a plurality of cellulose nanofibers having a chain entanglement structure and a dispersed phase formed from the cellulose nanocrystals, and thus shows significantly improved puncture strength, heat resistance and air permeability. Further, when using the secondary battery separator, it is possible to obtain a lithium secondary battery showing a significantly reduced risk of explosion caused by an internal short-circuit of a battery based on excellent ion conductivity, wettability with an electrolyte and heat stability.

In one aspect of the present disclosure, there is provided a secondary battery separator which includes a cellulose coating layer containing cellulose nanofibers and cellulose nanocrystals on one surface or both surfaces of a porous support, wherein the cellulose coating layer includes a continuous phase formed from a plurality of cellulose nanofibers having a chain entanglement structure and a dispersed phase formed from the cellulose nanocrystals.

According to an embodiment of the present disclosure, each of the cellulose nanofibers and cellulose nanocrystals may be prepared independently from cellulose fibers, and particularly, the cellulose fibers may be prepared from wood or non-wood pulp. The wood or non-wood pulp refers to pulp prepared from a wood or non-wood material, wherein the wood material may include coniferous trees, such as pine, fir and Japanese larch, and broad-leaved trees, such as eucalyptus, poplar and birch, or the like. The non-wood material includes cotton, rice straw, straw, reed, bagas, bamboo, kenaf, papyrus, flax, espato, jute, sabai, grass, hemp, corn stalk, banana leaves, golden fiber, abaca, coir, pineapple, ramie, sisal, henequen, yam, chaff, or the like. Pulp fibers can be produced through a pulping process to remove lignin from the wood or non-wood raw material, and the process may use a commonly used or known method with no particular limitation. Non-limiting examples of the wood or non-wood pulp may include unbleached coniferous pulp, unbleached broad-leaved pulp, bleached coniferous tree pulp, bleached broad-leaved tree pulp, waste newspaper regeneration pulp, tissue paper regeneration pulp, toilet paper and milk pack regeneration pulp, regenerated paper deinking pulp, non-wood pulp including cotton pulp and bamboo, or the like. In addition, any commercially available product may be used with no particular limitation.

According to an embodiment of the present disclosure, the cellulose nanofibers may have an average diameter of 20 nm or more, particularly, 20-500 nm, 50-500 nm, and more particularly, 50-300 nm, on the longitudinal section thereof. In addition, the cellulose nanofibers may have an average aspect ratio of 10 or more, particularly, 20-3000, and more particularly, 50-3000, or 10-1000.

According to an embodiment of the present disclosure, the cellulose nanofibers may be used in an amount of 10-99.9 wt %, particularly, 30-99.9 wt %, and more particularly, 70-95 wt %, based on the total weight of the cellulose coating layer.

According to an embodiment of the present disclosure, the cellulose nanocrystals may have an average diameter of 1 nm or more, particularly, 1-50 nm, and more particularly, 2-20 nm, on the longitudinal section thereof. In addition, the cellulose nanocrystals may have an average aspect ratio of 1 or more, particularly, 10-1000, and more particularly, 10-500.

According to an embodiment of the present disclosure, the cellulose nanocrystals may be used in an amount of 1-200 parts by weight, particularly 1-100 parts by weight, and more particularly, 5-50 parts by weight or 7-20 parts by weight, based on 100 parts by weight of the cellulose nanofibers.

When a coating layer containing nanocrystals is formed according to the related art, there is a problem in that the puncture strength is improved, but the air permeability is degraded contradictively. To solve this, the cellulose coating layer according to an embodiment of the present disclosure may be prepared from a cellulose coating composition including: cellulose nanofibers; cellulose nanocrystals; and a mixed solvent of water with an organic solvent having a higher boiling point than the boiling point of water. Particularly, the method for forming the cellulose coating layer is the same as described hereinafter.

According to an embodiment of the present disclosure, the cellulose coating layer may further include at least one selected from a dispersant and inorganic particles.

According to an embodiment of the present disclosure, the dispersant may be carboxymethyl cellulose. Carboxymethyl cellulose may be prepared from a wood material. For example, the wood material may include coniferous trees, such as pine, fir and Japanese larch, and broad-leaved trees, such as eucalyptus, poplar and birch, or the like. According to the present disclosure, considering the mechanical properties and the viscosity of the coating composition, carboxymethyl cellulose made from a wood material may be preferred to carboxymethyl cellulose made from cotton.

According to an embodiment of the present disclosure, carboxymethyl cellulose as a dispersant may be a cellulose derivative in which —OH group (hydroxyl group) of cellulose backbone is substituted with —OCH₂COOH and/or —OCH₂COO-M⁺ to be etherified. For example, M⁺ may be an alkali metal cation, and for example, may be any one selected from lithium (Li), sodium (Na), potassium (K), rubidium (Rb), cesium (Cs) and francium (Fr), or a combination of two or more of them.

According to an embodiment of the present disclosure, carboxymethyl cellulose as a dispersant may have a degree of substitution (DS) of 0.2-1.5, preferably 0.5-1.0, and more preferably, 0.6-0.9. Herein, the degree of substitution may be determined according to ASTM D1439, and refers to the number of the substituents contained in one glucose repeating unit forming cellulose.

According to an embodiment of the present disclosure, carboxymethyl cellulose as a dispersant may have a degree of crystallization of 20% or more, or 30% or more, but is not limited thereto, and the upper limit may be 50% or less, but is not limited thereto. The degree of crystallization may be determined by using a powder X-ray diffractomer according to a method known to those skilled in the art as a method for determining a degree of crystallization of a polymer.

According to an embodiment of the present disclosure, carboxymethyl cellulose as a dispersant may have an average diameter of 1 nm to 50 μm, particularly 5 nm to 10 μm, and more particularly 1 μm or less, in the state of powder, but is not limited thereto.

According to an embodiment of the present disclosure, carboxymethyl cellulose as a dispersant may have a degree of polymerization (DP) of 500-3,000, preferably 800-1,500, and more preferably, 1,100-1,300. Herein, carboxymethyl cellulose may have a weight average molecular weight (Mw) (as determined by gel permeation chromatography (GPC), standard material: polymethyl methacrylate (PMMA), solvent: tetrahydrofuran (THF)) of 100,000-800,000 g/mol, preferably 200,000-400,000 g/mol, and more preferably 220,000-350,000 g/mol.

According to an embodiment of the present disclosure, carboxymethyl cellulose as a dispersant may have a viscosity (25° C., Brookfield LVT, spindle #3, 30 rpm) of 200-2000 mPa/s, preferably 400-1500 mPa/s, and more preferably, 600-1000 mPa/s, in the state of 2 wt % aqueous solution.

According to an embodiment of the present disclosure, carboxymethyl cellulose as a dispersant may have a zeta potential of −75 to −50 mV, preferably −60 to −50 mV, and more preferably −55 to −50 mV, in the state of 1 wt % aqueous solution.

According to an embodiment of the present disclosure, the dispersant may be present in an amount of 10-300 parts by weight, preferably 50-200 parts by weight, and more preferably, 80-120 parts by weight, based on 100 parts by weight of the combined weight of the cellulose nanofibers and cellulose nanocrystals.

The secondary battery separator according to an embodiment of the present disclosure has a low heat shrinkage while not including inorganic particles, and thus shows excellent heat resistance. However, the secondary battery according to an embodiment of the present disclosure may further include inorganic particles in order to further improve the physical properties. As described above, the cellulose coating layer may have a structure in which a plurality of cellulose nanofibers forms a continuous phase (matrix) having a chain entanglement structure and the cellulose nanocrystals form a dispersed phase. Herein, the inorganic particles may be dispersed homogeneously in the continuous phase. The inorganic particles are not particularly limited, as long as they are known inorganic particles or currently used inorganic particles. Particularly, ceramic particles may be used. Particular examples of the inorganic particles may include any one selected from the group consisting of alumina, boehmite, magnesium oxide, calcium oxide, silicon oxide, yttrium oxide, zirconium oxide, zinc oxide, cerium oxide, nickel oxide, tin oxide, titanium oxide, calcium sulfate, barium sulfate, barium titanate, strontium titanate, calcium carbonate and derivatives thereof, or a combination of two or more of them. The inorganic particles may have an average particle diameter of 10 nm to 50 μm, preferably 0.5-10 μm, but is not limited thereto. The inorganic particles may be present in an amount of 0.1-50 wt %, preferably 0.5-40 wt %, and more preferably, 1-20 wt %, based on the total weight of the cellulose coating layer.

According to an embodiment of the present disclosure, the cellulose coating layer may have a thickness of 0.5-10 μm or 1-10 μm, preferably 2-8 μm, and more preferably, 2-7 μm, but is not limited thereto. According to the related art, it is difficult to form a coating layer containing cellulose nanocrystals to a large thickness due to the problem of degradation of air permeability. However, the cellulose separator according to an embodiment of the present disclosure is advantageous in that it can ensure excellent air permeability even when a coating layer is formed to a thickness of 0.5 μm or more, or 1 μm or more.

According to an embodiment of the present disclosure, it is possible to form a cellulose coating layer uniformly, wherein the cellulose coating layer includes a 1-dimensional (1D) continuous phase formed from a plurality of cellulose nanofibers having a chain entanglement structure and a dispersed phase formed from cellulose nanocrystals.

According to an embodiment of the present disclosure, any porous support may be used with no particular limitation, as long as it is a currently used or known porous support. Particularly, the porous support may be a conventional polyolefin-based polymer, but is not limited thereto. For example, the porous support may include any one selected from the group consisting of high-density polyethylene, low-density polyethylene, linear low-density polyethylene, ultrahigh-molecular weight polyethylene, polypropylene, polybutylene, polypentene, polypropylenepolyethylene terephthalate, polybutylene terephthalate, polyester, polyacetal, polyamide, polycarbonate, polyimide, polyetheretherketone, polyethersulfone, polyphenylene oxide, polyphenylene sulfide and polyethylene naphthalene, or a combination of two or more of them. In addition, the porous support may have a thickness of 1-50 μm, preferably 5-20 μm.

According to an embodiment of the present disclosure, the secondary battery separator may have an air permeability (Gurley value) of 800 s/100 cc or less, particularly 1-800 s/100 cc, 10-600 s/100 cc, 10-500 s/100 cc, or 50-400 s/100 cc. Although the secondary battery separator includes a large amount of cellulose nanocrystals, it may show a significantly improved air permeability.

According to an embodiment of the present disclosure, the secondary battery separator may have a puncture strength of 5 N or more, particularly 5-20 N, and more particularly, 6-15 N or 7-10 N. Since the secondary battery separator includes a cellulose coating layer containing cellulose nanocrystals, it may have excellent puncture strength. In addition, the secondary battery including the separator may realize improved stability against an internal short-circuit of a cell caused by external impact or lithium dendrite.

In another aspect of the present disclosure, there is provided a secondary battery including the secondary battery separator. The secondary battery may include a positive electrode, a negative electrode, an electrolyte and the above-described secondary battery separator interposed between the positive electrode and the negative electrode. Each of the positive electrode, the negative electrode and the electrolyte may be prepared with ease through a process and/or method used currently in the art or known to those skilled in the art, or a commercially available product may be used with no particular limitation. In the case of a secondary battery including the secondary battery separator according to an embodiment, it has high ion-conductivity and shows excellent battery performance. In addition, since the secondary battery includes such a separator having excellent heat resistance and puncture strength, it shows excellent durability and a significantly reduced risk of explosion caused by an internal short-circuit of a cell resulting from external impact or lithium dendrite, and thus realizes improved stability. Therefore, the secondary battery may be applied widely to large-capacity batteries for vehicles, or the like.

In still another aspect of the present disclosure, there is provided a method for manufacturing a secondary battery separator, including a step of applying a cellulose coating composition containing cellulose nanofibers and cellulose nanocrystals onto one surface or both surfaces of a porous support to form a cellulose coating layer, wherein the solvent is a mixed solvent of water with an organic solvent having a higher boiling point than the boiling point of water, and the cellulose coating layer includes a continuous phase formed from a plurality of cellulose nanofibers having a chain entanglement structure and a dispersed phase formed from the cellulose nanocrystals.

According to an embodiment of the present disclosure, the cellulose coating composition may include a solvent, cellulose nanofibers and cellulose nanocrystals. In addition, the cellulose coating composition may further include at least one of the above-described inorganic particles and dispersant. Reference will be made to the above description of the cellulose nanofibers, the cellulose nanocrystals, the inorganic particles and the dispersant, and thus detailed description thereof will be omitted.

According to an embodiment of the present disclosure, the solvent may be water or a mixed solvent of water with an organic solvent having a higher boiling point than the boiling point of water. Particularly, the organic solvent having a higher boiling point than the boiling point of water may be an organic solvent having a boiling point at least 10° C. higher, preferably at least 20° C. higher, and more preferably at least 50° C. higher or at least 70° C. higher than the boiling point of water, and the upper limit may be 200° C. or lower, but is not limited thereto. For example, the organic solvent having a higher boiling point than the boiling point of water may include any one selected from the group consisting of butanol, dimethyl sulfoxide (DMSO), N,N-dimethylformamide (DMF), N-methyl-2-pyrrolidone (NMP), ethylene glycol (EG), acetic acid, acetic anhydride, hexamethylphosphoramide (HMPA), pyridine, toluene and xylene, or a combination of two or more of them, but is not limited thereto.

When the solvent is a mixed solvent, the weight ratio of water to the organic solvent having a higher boiling point than the boiling point of water may be 1-20:1, preferably 2-10:1, and more preferably, 2-8:1. When the solvent is a mixed solvent and the above-defined weight ratio is satisfied, the secondary battery separator according to an embodiment of the present disclosure may have further improved air permeability.

According to an embodiment of the present disclosure, the coating composition may have a solid content of 1-20 wt %, preferably 2-17 wt %, and more preferably, 3-15 wt %.

According to an embodiment of the present disclosure, the coating composition may have a viscosity of 20-1000 mPa/s, preferably 30-600 mPa/s, and more preferably 50-500 mPa/s or 100-400 mPa/s.

According to an embodiment of the present disclosure, the method for applying a cellulose coating composition may be a conventional or known method for applying a liquid phase onto a substrate. For example, dip coating, die coating, roll coating, comma coating, bar coating or spray coating may be used, but the scope of the present disclosure is not limited thereto. For example, the cellulose coating composition may be applied under a humidity condition of 10-80% RH (relative humidity).

In addition, a step of drying the coating composition may be further carried out after the coating composition-applying step in order to dry the solvent. The drying step may be carried out by a conventional or known method for drying a liquid phase. For example, hot air drying may be used, but the scope of the present disclosure is not limited thereto. For example, the drying step may be carried out at a temperature of 40-80° C.

Hereinafter, the present disclosure will be explained in more detail with reference to Examples and Comparative Example. However, the following Examples and Comparative Examples are for illustrative purposes only, and the scope of the present disclosure is not limited thereto.

### Method for Evaluating Physical Properties

### 1) Average Diameter and Average Length (nm or μm):

Ten cellulose nanofibers, cellulose nanocrystals or carboxymethyl cellulose selected randomly from a microscopic image were determined in terms of diameter and length, and the measured values and aspect ratios were averaged excluding each of the maximum and minimum values.

2) Viscosity [mPa/s]

The viscosity was determined at room temperature (25+2° C.) by using a viscometer (Brookfield LVT) with a spindle #3 under the condition of 30 rpm.

### 3) Puncture Strength [N]

The secondary battery separator obtained from each of Examples and Comparative Examples and having a thickness of 11 μm (including a cellulose coating layer having a thickness of 5 μm) was determined in terms of puncture strength according to ASTM D 4830 at a rate of 300 mm/min. The results are shown in the following Table 1.

### 4) Heat Resistance [%]

The length and width of the secondary battery separator obtained from each of Examples and Comparative Examples was measured, and the secondary battery separator was allowed to stand at a temperature of 130° C. for 1 hour. Then, the dimensional change was measured to calculate the heat shrinkage. The results are shown in the following Table 1.

5) Air Permeability (Gurley Value) [s/100 cc, air]

The time required for 100 cc of air to pass through an area of 1 inch² of the secondary battery separator obtained from each of Examples and Comparative Examples under a pressure of 1.2 KPa was measured. The results are shown in the following Table 1.

### 6) Ion Conductivity [S/cm]

The secondary battery separator obtained from each of Examples and Comparative Examples was interposed between lithium metal sheets (thickness 1 mm). In addition, a coin cell type battery was manufactured according to the conventional method by using an electrolyte including 1 M LiPF₆ dissolved in a mixed solvent containing ethylene carbonate (EC) and diethyl carbonate (DEC) at a volume ratio of 1:1 (EC/DEC). Then, the ion conductivity of the coin cell was determined. As electrolyte, 1 M LiPF₆ in EC/DEC (1:1, v/v) was used. The ion conductivity was calculated through electrochemical impedance spectroscopy (EIS) (analysis condition: frequency 1.0 MHZ to 0.1 Hz, amplitude potential 10 mV) and according to the following formula. The results are shown in the following Table 1.

$$σ [ S / cm ] = \frac{L [ cm ]}{R [ Ω ] A [ {cm}^{2} ]} \qquad [ Formula ]$$

wherein σ represents ion conductivity, R represents resistance (Z), L represents thickness, and A represents area.

### 7) Li/Li Symmetric Cell Test

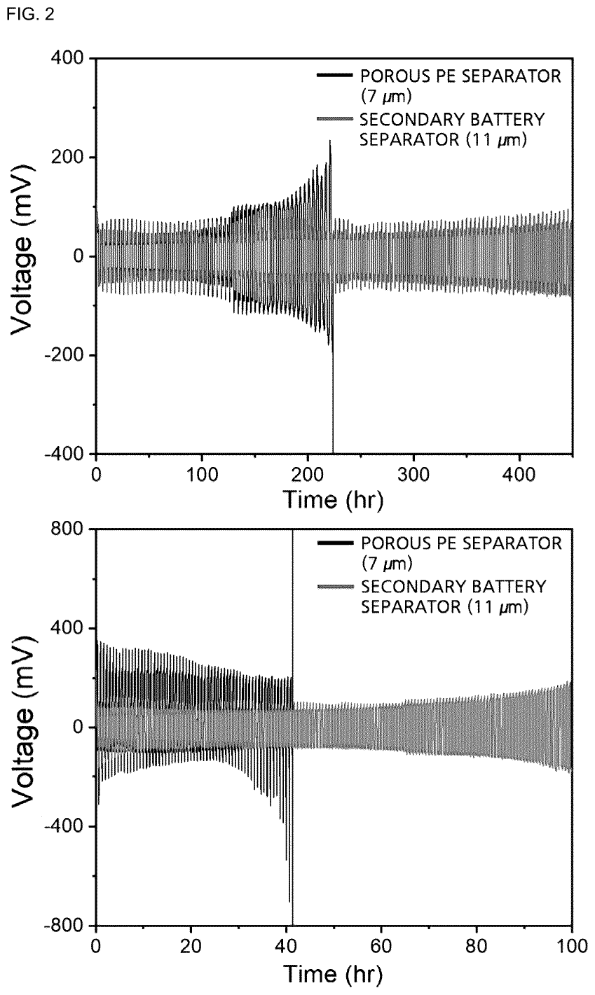

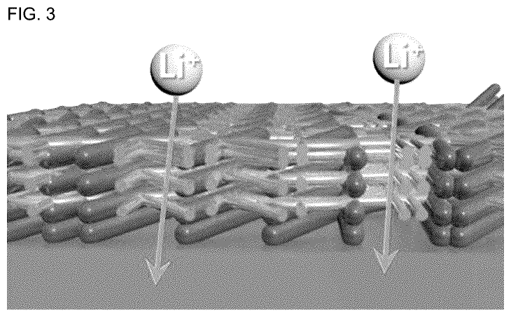

A plating-stripping test of an Li/Li symmetric cell using the secondary battery separator was carried out. A voltage curve depending on time was plotted under a current condition of (A) 1 mAh/cm² at 0.5 mA/cm², and (B) 1 mAh/cm² at 3 mA/cm². The plotted voltage curve is shown in FIG. 2. Referring to FIG. 2, when the secondary battery separator according to an embodiment of the present disclosure is used, a stable voltage curve appears for a long time, which suggests that improvement of puncture strength provides an effect of reducing an internal short-circuit of a cell.

### EXAMPLE 1

### Preparation of Coating Composition

To a mixed solvent containing distilled water and N-methyl-2-pyrrolidone (NMP) at a weight ratio of 8:2, 9 wt % of cellulose nanofibers (average diameter: about 55 nm, average aspect ratio: about 200) and 1 wt % of cellulose nanocrystals (average diameter: about 6 nm, average aspect ratio: 100) were introduced. Next, the resultant mixture was agitated sufficiently at room temperature to prepare a coating composition of Example 1 having a solid content of 10 wt %.

### Manufacture of Secondary Battery Separator

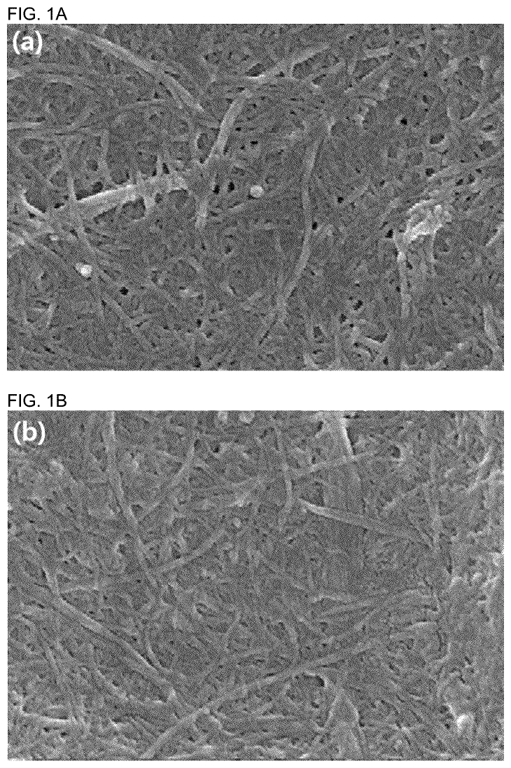

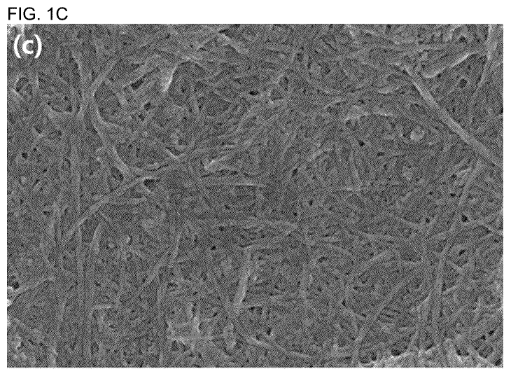

A porous polyethylene (PE) separator (7 μm) was fixed, the coating composition prepared as described above was applied onto the separator by using an automatic bar coater, and hot air drying was carried out sufficiently at a temperature of about 60° C. In this manner, a secondary battery separator (11 μm) having a cellulose coating layer (4 μm) was finished. The surface of the resultant secondary battery separator was analyzed by scanning electron microscopy (SEM). The SEM image is shown in FIGS. 1A to 1C. In addition, the porous PE separator (7 μm) and the secondary battery separator (11 μm) were subjected to a Ll/Li symmetric cell test. The results are shown in FIG. 2.

### EXAMPLE 2

Example 1 was repeated, except that 5 wt % of cellulose nanofibers and 5 wt % of cellulose nanocrystals were introduced.

### EXAMPLE 3

Example 1 was repeated, except that 0.5 wt % of cellulose nanofibers and 9.5 wt % of cellulose nanocrystals were introduced.

### COMPARATIVE EXAMPLE 1

Example 1 was repeated, except that distilled water was used instead of the mixed solvent.

### COMPARATIVE EXAMPLE 2

Example 1 was repeated, except that a mixed solvent including distilled water and ethanol at a weight ratio of 8:2 was used.

### COMPARATIVE EXAMPLE 3

Comparative Example 1 was repeated, except that cellulose nanocrystals were not introduced but 10 wt % of cellulose nanofibers were introduced.

The following Table 1 shows the results of evaluation of the physical properties of each secondary battery separator.

TABLE 1

| | Viscosity | | Heat | | |
|---|---|---|---|---|---|
| | of coating | Puncture | shrink- | Air | Ion |
| | composition | strength | age | permeability | conductivity |
| | [mPa/s] | [N] | [%] | [s/100 cc] | [S/cm] |
| Ex. 1 | 140 | 7.4 | 0.2 | 290 | 7.2 × 10⁻⁴ |
| Ex. 2 | 180 | 7.7 | 0.2 | 460 | 6.0 × 10⁻⁴ |
| Ex. 3 | 130 | 6.5 | 0.2 | 260 | 7.3 × 10⁻⁴ |
| Comp. | 150 | 7.3 | 0.2 | Not | 3.0 × 10⁻⁶ |
| Ex. 1 | | | | available | |
| Comp. | 100 | 7.4 | 0.2 | Not | 2.0 × 10⁻⁶ |
| Ex. 2 | | | | available | |
| Comp. | 110 | 5.8 | 0.2 | 300 | 7.0 × 10⁻⁴ |
| Ex. 3 | | | | | |

As shown in Table 1, when the separator includes cellulose nanofibers and cellulose nanocrystals and uses a mixed solvent as a solvent, it shows excellent puncture strength and improved air permeability.

Particularly, when comparing Example 1 with Comparative Examples 1 and 2, use of a mixed solvent including water with an organic solvent having a higher boiling point that the boiling point of water can ensure excellent air permeability. Particularly, referring to FIGS. 1A to 1C, the pores of the cellulose coating layer are hardly observed in Comparative Examples 1(b) and 2(c), but it can be seen that the pores are formed in the cellulose coating layer of Example 1(a). This demonstrates that it is possible to solve the problem of degradation of air permeability occurring when forming a coating layer containing cellulose nanocrystals according to the related art. Further, the secondary battery separator according to each Example shows an ion conductivity of 1.0×10⁻⁵ S/cm or more, preferably 5.0×10⁻⁴ to 1×10⁻³ S/cm. This demonstrates that the secondary battery separator according to each Example can realize a low heat shrinkage, excellent air permeability and significantly high puncture strength.

In addition, while the cellulose coating layer is formed to a thickness of about 4 μm according to an embodiment of the present disclosure, the secondary battery separator has a significantly smaller weight as compared to the related art using an acryl binder, or the like, and thus can be light-weighted.

The present disclosure has been described in detail with reference to specific embodiments, examples and drawings. However, it should be understood that the detailed description and specific examples are given by way of illustration only, and thus scope of the present disclosure is not limited thereto. In addition, various changes and modifications within the scope of the disclosure will become apparent to those skilled in the art from this detailed description. Therefore, the description proposed herein is just a preferable example for the purpose of illustrations only, not intended to limit the scope of the disclosure, so it should be understood that other equivalents and modifications could be made thereto without departing from the scope of the disclosure.

What is claimed is:

1. A secondary battery separator which comprises a cellulose coating layer containing cellulose nanofibers and cellulose nanocrystals on one surface or both surfaces of a porous support, wherein the cellulose coating layer comprises a continuous phase formed from a plurality of cellulose nanofibers having a chain entanglement structure and a dispersed phase formed from the cellulose nanocrystals.

2. The secondary battery separator according to claim 1, wherein the cellulose nanocrystals are present in an amount of 1-200 parts by weight based on 100 parts by weight of the cellulose nanofibers.

3. The secondary battery separator according to claim 1, wherein the cellulose nanofibers have an average diameter of 50-500 nm on the longitudinal section thereof.

4. The secondary battery separator according to claim 1, wherein the cellulose nanofibers have an average aspect ratio of 50-3000.

5. The secondary battery separator according to claim 1, wherein the cellulose nanocrystals have an average diameter of 1-50 nm on the longitudinal section thereof.

6. The secondary battery separator according to claim 1, wherein the cellulose nanocrystals have an average aspect ratio of 10-1000.

7. The secondary battery separator according to claim 1, wherein the cellulose coating layer is prepared from a cellulose coating composition comprising: cellulose nanofibers; cellulose nanocrystals; and a mixed solvent of water with an organic solvent having a higher boiling point than the boiling point of water.

8. The secondary battery separator according to claim 1, wherein the cellulose coating layer has a thickness of 1-10 μm.

9. The secondary battery separator according to claim 1, wherein the cellulose coating layer further comprises at least one selected from a dispersant and inorganic particles.

10. The secondary battery separator according to claim 1, wherein the porous support comprises any one selected from the group consisting of high-density polyethylene, low-density polyethylene, linear low-density polyethylene, ultrahigh-molecular weight polyethylene, polypropylene, polybutylene, polypentene, polypropylenepolyethylene terephthalate, polybutylene terephthalate, polyester, polyacetal, polyamide, polycarbonate, polyimide, polyetheretherketone, polyethersulfone, polyphenylene oxide, polyphenylene sulfide and polyethylene naphthalene, or a combination of two or more of them.

11. The secondary battery separator according to claim 1, which has an air permeability (Gurley value) of 600 s/100 cc air or less.

12. The secondary battery separator according to claim 1, which has a puncture strength of 5 N or more.

13. A secondary battery comprising the secondary battery separator as defined in claim 1.

14. A method for manufacturing a secondary battery separator, comprising a step of applying a cellulose coating composition containing cellulose nanofibers and cellulose nanocrystals onto one surface or both surfaces of a porous support to form a cellulose coating layer, wherein the solvent is a mixed solvent of water with an organic solvent having a higher boiling point than the boiling point of water, and the cellulose coating layer comprises a continuous phase formed from a plurality of cellulose nanofibers having a chain entanglement structure and a dispersed phase formed from the cellulose nanocrystals.

15. The method for manufacturing a secondary battery separator according to claim 14, wherein the organic solvent comprises any one selected from the group consisting of butanol, dimethyl sulfoxide (DMSO), N,N-dimethylformamide (DMF), N-methyl-2-pyrrolidone (NMP), ethylene glycol (EG), acetic acid, acetic anhydride, hexamethylphosphoramide (HMPA), pyridine, toluene and xylene, or a combination of two or more of them.

16. The method for manufacturing a secondary battery separator according to claim 14, wherein mixed solvent comprises water and the organic solvent at a weight ratio of 2-10:1.

17. The method for manufacturing a secondary battery separator according to claim 14, wherein the coating composition has a solid content of 1-20 wt %.
